(19) United States
(12) Patent Application Publication
(10) Pub. No.: US 2026/0184279 A1
(43) Pub. Date: Jul. 2, 2026

(54) VEHICLE FRONT SECTION STRUCTURE

(71) Applicant: TOYOTA JIDOSHA KABUSHIKI KAISHA, Aichi-ken (JP)

(72) Inventors: Ayaka KAGAMI, Inazawa-shi (JP); Soshiro MURATA, Toyota-shi (JP)

(21) Appl. No.: 19/409,739

(22) Filed: Dec. 5, 2025

(30) Foreign Application Priority Data
Dec. 27, 2024 (JP) 2024-233040

(51) Int. Cl. B60R 19/34

(52) U.S. Cl. CPC B60R 19/34

(57) ABSTRACT

A vehicle front section structure including: a front side member that extends in a vehicle front-rear direction; a crash box that is disposed further toward a vehicle front side than the front side member; a bumper reinforcement that is disposed further toward the vehicle front side than the crash box and that extends in a vehicle width direction; and a receiving member that is disposed between and couples the front side member and the crash box and that projects out further toward a vehicle width direction outer side than the front side member, a bent portion that is bent toward the vehicle front side and toward a vehicle width direction inner side being provided at an end portion at a vehicle width direction outer side of the receiving member.

### CROSS-REFERENCE TO RELATED APPLICATION

This application is based on and claims priority under 35 USC 119 from Japanese Patent Application No. 2024-233040 filed on Dec. 27, 2024, the disclosure of which is incorporated by reference herein.

### BACKGROUND

### Technical Field

The present disclosure relates to a vehicle front section structure.

### Related Art

Japanese Patent Application Laid-Open (JP-A) No. 2016-78492 discloses a structure including a front projection portion and a rear projection portion at both end portions of a bumper reinforcement, and the rear projection portion presses a front side member to bend and deform the front side member during a small overlap collision.

However, in a configuration in which collision energy is absorbed due to bending and deforming of a front side member as in JP-A No. 2016-78492, advancement of a collision body toward a cabin cannot be avoided, and thus, there is room for improvement.

### SUMMARY

An object of the present disclosure is to obtain a vehicle front section structure that enables a vehicle to effectively escape from a collision body during a small overlap collision.

A vehicle front section structure according to a first aspect includes: a front side member that extends in a vehicle front-rear direction; a crash box that is disposed further toward a vehicle front side than the front side member; a bumper reinforcement that is disposed further toward the vehicle front side than the crash box and that extends in a vehicle width direction; and a receiving member that is disposed between and couples the front side member and the crash box and that projects out further toward a vehicle width direction outer side than the front side member, a bent portion that is bent toward the vehicle front side and toward a vehicle width direction inner side being provided at an end portion at a vehicle width direction outer side of the receiving member.

In the vehicle front section structure according to the first aspect, the crash box is disposed at a vehicle front side of the front side member, and the bumper reinforcement is disposed at a vehicle front side of the crash box. Further, the receiving member is disposed between the front side member and the crash box, and the receiving member couples the front side member and the crash box. Furthermore, the receiving member includes the bent portion that projects out further toward the vehicle width direction outer side than the front side member, and the bent portion is bent toward the vehicle front side and toward the vehicle width direction inner side at the end portion at the vehicle width direction outer side thereof. Consequently, the bumper reinforcement can be received by the receiving member at a face thereof when an end portion of the bumper reinforcement is bent and deformed during a small overlap collision, and a lateral force can be effectively generated at a vehicle body. As a result, the vehicle body can be caused to escape from a collision body.

A vehicle front section structure according to a second aspect is the vehicle front section structure according to the first aspect, wherein an edge of a leading end of the bent portion is rounded.

In the vehicle front section structure according to the second aspect, breakage due to concentration of stress at the leading end of the bent portion of the receiving member can be suppressed.

A vehicle front section structure according to a third aspect is the vehicle front section structure according to the first aspect, wherein the receiving member is integrally formed with the front side member by casting.

In the vehicle front section structure according to the third aspect, since the receiving member and the front side member are integrally formed by casting, a number of components can be reduced, compared to a configuration in which each of these is a separate body.

A vehicle front section structure according to a fourth aspect is the vehicle front section structure according to the third aspect, wherein the receiving member is configured to include plural lateral ribs that are disposed at intervals in a vehicle up-down direction, and vertical ribs that connect vertically adjacent lateral ribs to each other.

In the vehicle front section structure according to the fourth aspect, the receiving member can be reinforced by the vertical ribs.

A vehicle front section structure according to a fifth aspect is the vehicle front section structure according to any one of the first aspect to the fourth aspect, which further includes a cover portion that covers an open cross-section of the bent portion.

In the vehicle front section structure according to the fifth aspect, since the open cross-section of the bent portion is covered by the cover portion, the bumper reinforcement can be received at a face thereof.

As explained above, the vehicle front section structure according to the present disclosure enables a vehicle to effectively escape from a collision body during a small overlap collision.

### BRIEF DESCRIPTION OF THE DRAWINGS

An exemplary embodiment of the present disclosure will be described in detail based on the following figures, wherein:

FIG. 1 is a plan view illustrating relevant portions of a vehicle front section structure according to an exemplary embodiment;

FIG. 2 is a perspective view illustrating a receiving member of the exemplary embodiment; and

FIG. 3 is a plan view illustrating relevant portions of a vehicle front section structure according to a modified example.

### DETAILED DESCRIPTION

A vehicle front section structure according to an exemplary embodiment will be explained, with reference to the drawings.

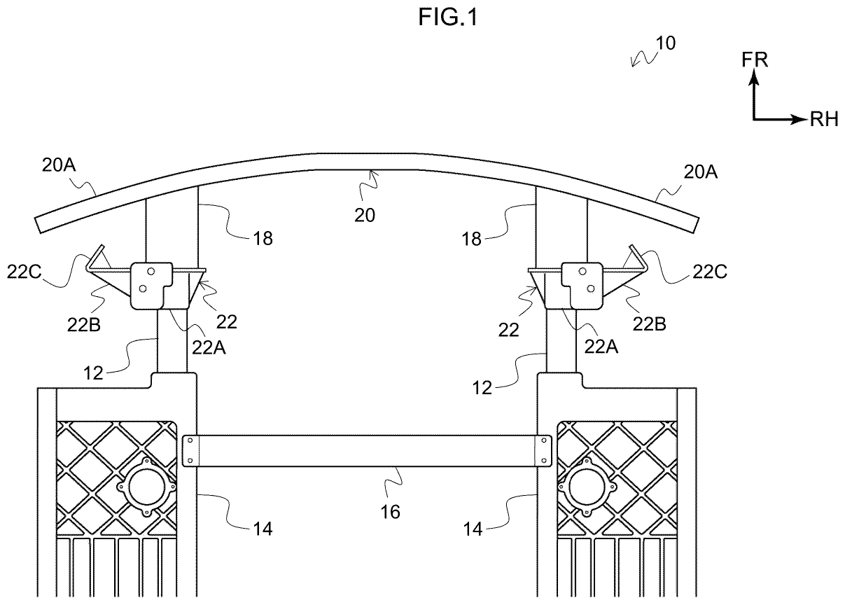

FIG. 1 is a plan view illustrating relevant portions of a vehicle front section structure according to the exemplary embodiment. It should be noted that, in the drawings, arrow RR, arrow UP, and arrow RH respectively indicate a vehicle rearward direction, a vehicle upward direction, and a vehicle rightward direction of a vehicle. Unless specifically stated otherwise, in cases in which front and rear, up and down, and left and right directions are used in the following explanation, these respectively indicate front and rear in a vehicle front-rear direction, up and down in a vehicle up-down direction, and left and right in a vehicle left-right direction (width direction).

As illustrated in FIG. 1, front side members 12 extending in the vehicle front-rear direction are provided at a front section of a vehicle 10 to which the vehicle front section structure is applied. A left and right pair of the front side members 12 are provided, and a rear end portion of each front side member 12 is connected to a suspension tower 14.

The left and right suspension towers 14 are coupled in the vehicle width direction by a brace 16. In this regard, in the present exemplary embodiment, as an example, the suspension towers 14 and the front side members 12 are die-cast components that are integrally formed by casting. It should be noted that there is no limitation thereto, and that the front side members 12 and the suspension towers 14 may be formed as separate bodies. Further, the brace 16 is formed by a steel plate that is a separate body from the die-cast components.

Crash boxes 18 are disposed further toward a vehicle front side than the front side members 12. A left and right pair of the crash boxes 18 are disposed, and each of the crash boxes 18 extends in the vehicle front-rear direction. Further, the crash boxes 18 are configured so as to be capable of being crushed to absorb at least a portion of collision energy due to a collision load being input during a frontal collision of the vehicle. For example, a fragile portion or the like, serving as a starting point of the crushing when a collision load is input, may be formed at each crash box 18.

A bumper reinforcement 20 is disposed further toward the vehicle front side than the crash boxes 18. The bumper reinforcement 20 extends in the vehicle width direction, and is configured to have a rounded shape such that a vehicle width direction central portion thereof bulges toward the vehicle front side in plan view. Further, the bumper reinforcement 20 couples the left and right crash boxes 18 in the vehicle width direction.

Extension portions 20A are respectively provided at both vehicle width direction end portions of the bumper reinforcement 20 so as to extend further toward vehicle width direction outer sides than the front side members 12 and the crash boxes 18. In a collision mode in which a collision occurs further toward the vehicle width direction outer side than the front side member 12, such as in a small overlap collision, the extension portion 20A of the bumper reinforcement 20 is bent and deformed toward a vehicle rear side.

Receiving members 22 are respectively provided between the front side members 12 and the crash boxes 18. The receiving member 22 couples the front side member 12 and the crash box 18 at the front and rear, and in the present exemplary embodiment, the receiving member 22 is formed as a die-cast component that is a separate body from the front side member 12. It should be noted that there is no limitation thereto, and that the front side members 12 and the receiving members 22 may be integrally formed by casting.

Each receiving member 22 is configured mainly including a joining portion 22A to which the front side member 12 is joined, a projecting portion 22B that projects out further toward the vehicle width direction outer side than the front side member 12, and a bent portion 22C that is bent toward the vehicle front side and toward a vehicle width direction inner side from an end portion of the projecting portion 22B.

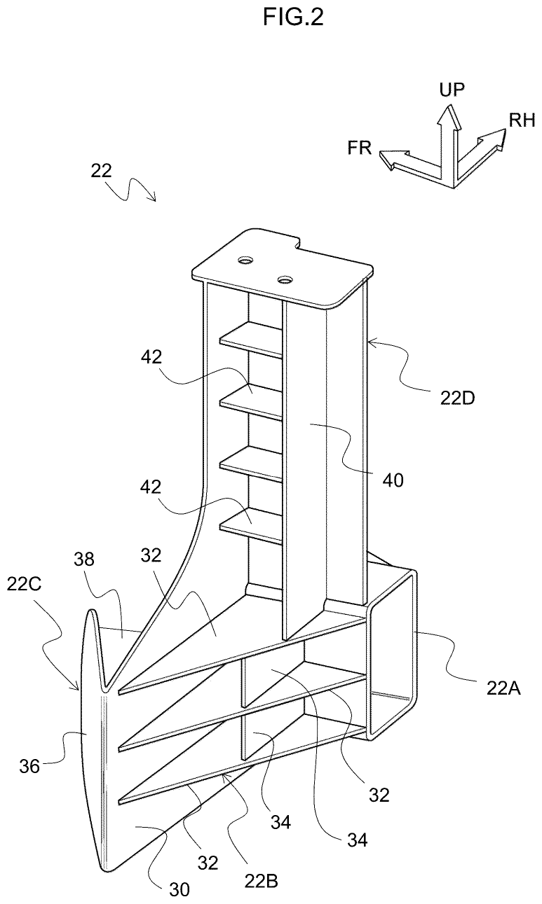

FIG. 2 is a perspective view illustrating a receiving member 22 of the exemplary embodiment. As illustrated in FIG. 2, an opening portion into which the front side member 12 can be inserted is formed at the joining portion 22A of the receiving member 22, and the joining portion 22A is configured such that the receiving member 22 can be mechanically fastened to the front side member 12 by a bolt and a nut, or the like, in a state of being inserted into the front side member 12.

The projecting portion 22B extends toward the vehicle width direction outer side from a side wall of the joining portion 22A. FIG. 2 illustrates the receiving member 22 at a vehicle left side, and the projecting portion 22B projects out toward the vehicle left side from the joining portion 22A. Further, the projecting portion 22B is formed in a substantially triangular shape in plan view.

In this regard, a front end of the receiving member 22 is configured to include a front plate portion 30 that extends in the vehicle width direction and the vehicle up-down direction. A lower portion of the front plate portion 30 extends out further toward the vehicle width direction outer side than an upper portion thereof, and the lower portion of the front plate portion 30 configures the projecting portion 22B.

The projecting portion 22B is provided with plural lateral ribs 32 that are arranged at intervals in the up-down direction. Each lateral rib 32 is formed in a substantially triangular shape in plan view, and in the present exemplary embodiment, as an example, three lateral ribs 32 are formed.

One side among the three sides of each of the three lateral ribs 32 is connected to the front plate portion 30, and another side among the three sides of each of the three lateral ribs 32 is connected to the side wall of the joining portion 22A. Further, vertical ribs 34 are respectively provided between lateral ribs 32 that are vertically adjacent to each other, and the lateral ribs 32 that are above and below are connected to each other by the vertical ribs 34.

The vertical ribs 34 are each formed in a substantially rectangular plate shape when viewed from the vehicle front-rear direction, and are formed at positions at which the two vertical ribs 34 overlap with each other in plan view. Further, in the present exemplary embodiment, the vertical ribs 34 are formed substantially parallel to the front plate portion 30.

The bent portion 22C includes a cover portion 36 that extends from a vehicle width direction end portion of the front plate portion 30 toward the vehicle front side and toward the vehicle width direction inner side. The cover portion 36 is integrally formed with the front plate portion 30, and a bent part between the cover portion 36 and the front plate portion 30 is rounded. That is to say, an edge of a leading end of the bent portion 22C is rounded.

Front side lateral ribs 38 are provided so as to span between the cover portion 36 and the front plate portion 30. Although not illustrated in the drawings, three front side lateral ribs 38 are provided at intervals in the vehicle up-down direction, similarly to the lateral ribs 32 of the projecting portion 22B.

In this regard, although the bent portion 22C in the present exemplary embodiment is configured such that an open cross-section formed by the front side lateral ribs 38 is covered by the cover portion 36, there is no limitation thereto, and a configuration may be provided in which the cover portion 36 is not provided. In such a case, the bent portion 22C is configured by the front side lateral ribs 38.

A reinforcing portion 22D is provided at an upper portion of the receiving member 22. A front portion of the reinforcing portion 22D is configured to include an upper portion of the front plate portion 30, and the reinforcing portion 22D includes four reinforcing lateral ribs 42 that are disposed at intervals in the vehicle up-down direction along the front plate portion 30.

The reinforcing lateral ribs 42 are each formed in a substantially rectangular shape in plan view, and are provided so as to span between the front plate portion 30 and a rear plate portion 40 that faces the front plate portion 30.

### Operation

Next, operation of the vehicle front section structure according to the present exemplary embodiment will be explained.

As illustrated in FIG. 1, in the present exemplary embodiment, the crash boxes 18 are disposed at the vehicle front sides of the front side members 12, and the bumper reinforcement 20 is disposed at the vehicle front side of the crash boxes 18. Further, the receiving members 22 are disposed between the front side members 12 and the crash boxes 18, and the receiving members 22 couple the front side members 12 and the crash boxes 18.

In this regard, each receiving member 22 includes the bent portion 22C that projects out further toward the vehicle width direction outer side than the front side member 12, and the bent portion 22C is bent toward the vehicle front side and toward the vehicle width direction inner side at the end portion at the vehicle width direction outer side thereof. Consequently, the extension portion 20A of the bumper reinforcement 20 can be received by the receiving member 22 at a face thereof when the end portion of the bumper reinforcement 20 is bent and deformed during a small overlap collision, and a lateral force can be effectively generated at the vehicle body. As a result, the vehicle body can be caused to escape from the collision body.

Further, as illustrated in FIG. 2, in the present exemplary embodiment, since the leading end of the bent portion 22C of the receiving member 22 is rounded, breakage due to concentration of stress at the bent portion 22C can be suppressed.

Furthermore, in the present exemplary embodiment, since the receiving member 22 and the front side member 12 are integrally formed by casting, a number of components can be reduced, compared to a configuration in which each of these is a separate body.

Moreover, in the present exemplary embodiment, the projecting portion 22B is configured to include the lateral ribs 32 and the vertical ribs 34 that vertically connect the lateral ribs 32. Thus, the receiving member 22 can be reinforced by the vertical ribs 34.

Further, in the present exemplary embodiment, since the open cross-section of the bent portion 22C is covered by the cover portion 36, the bumper reinforcement 20 can be received at the face thereof.

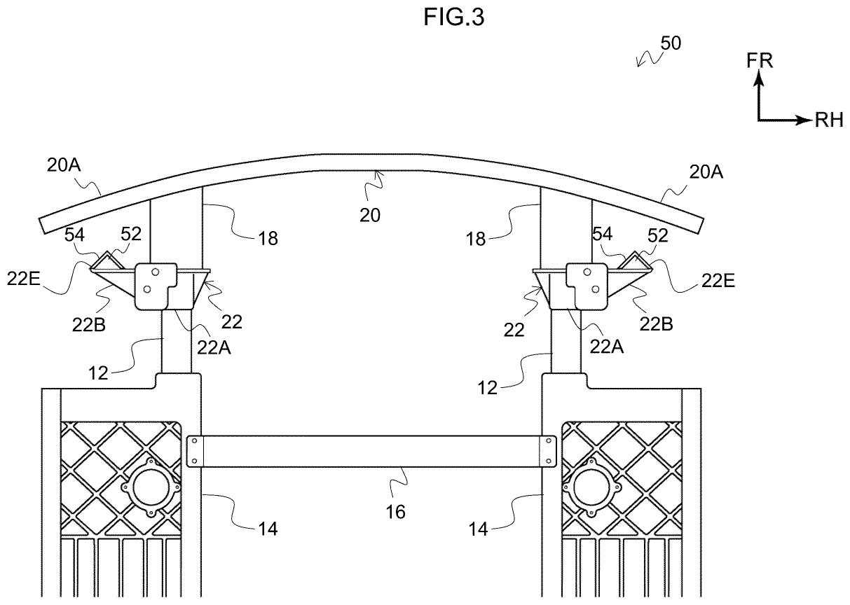

It should be noted that, in the present exemplary embodiment, although the bent portion 22C is configured by the cover portion 36 and the front side lateral ribs 38, there is no limitation thereto. For example, the configuration of a modified example illustrated in FIG. 3 may be employed.

### Modified Example

FIG. 3 is a plan view illustrating relevant portions of a vehicle front section structure according to a modified example. As illustrated in FIG. 3, a vehicle 50 to which the vehicle front section structure according to the present modified example is applied is different from the exemplary embodiment in that bent portions 22E are provided in place of the bent portions 22C.

Each bent portion 22E includes plural front side lateral ribs 52 that are disposed at intervals in the vehicle up-down direction. Although not illustrated in the drawings, in the present modified example, three front side lateral ribs 52 are provided in the vehicle up-down direction. The front side lateral ribs 52 are each formed in a substantially triangular shape in plan view.

Further, the bent portion 22E is provided with a cover portion 54. The cover portion 54 is formed substantially in a V-shape in plan view so as to cover outer peripheral end portions of the front side lateral ribs 52, and is fixed to the front side lateral ribs 52 and the front plate portion 30. It should be noted that a height of the cover portion 54 in the up-down direction is configured to be a height that can sufficiently cover the three front side lateral ribs 52.

In the present modified example, by providing the cover portion 54 that is substantially V-shaped in plan view, a collision load that has been input from the bumper reinforcement 20 can be effectively received at a face thereof.

Although the vehicle front section structure according to the present disclosure has been explained above, it goes without saying that various embodiments can be implemented within a range that does not depart from the spirit of the present disclosure. For example, although the brace 16 is provided between the suspension towers 14 in the present exemplary embodiment, there is no limitation thereto, and a configuration may be provided in which the brace 16 is not provided.

Further, in the present exemplary embodiment, although a configuration has been explained in which the receiving member 22 is provided with the reinforcing portion 22D as illustrated in FIG. 2, there is no limitation thereto, and a configuration may be provided in which the reinforcing portion is not provided.

Furthermore, in the present exemplary embodiment, although the receiving member 22 is integrally formed by casting so as to include the joining portion 22A, the projecting portion 22B, and the bent portion 22C, there is no limitation thereto. For example, the bent portion 22C may be formed as a separate body.

With regard to the above-described exemplary embodiment, the following additional notes are further disclosed.

### Additional Note 1

A vehicle front section structure including:
a front side member that extends in a vehicle front-rear direction;
a crash box that is disposed further toward a vehicle front side than the front side member;
a bumper reinforcement that is disposed further toward the vehicle front side than the crash box and that extends in a vehicle width direction; and
a receiving member that is disposed between and couples the front side member and the crash box and that projects out further toward a vehicle width direction outer side than the front side member, a bent portion that is bent toward the vehicle front side and toward a vehicle width direction inner side being provided at an end portion at a vehicle width direction outer side of the receiving member.

### Additional Note 2

The vehicle front section structure according to Additional Note 1, wherein an edge of a leading end of the bent portion is rounded.

### Additional Note 3

The vehicle front section structure according to Additional Note 1 or 2, wherein the receiving member is integrally formed with the front side member by casting.

### Additional Note 4

The vehicle front section structure according to any one of Additional Notes 1 to 3, wherein the receiving member is configured to include plural lateral ribs that are disposed at intervals in a vehicle up-down direction, and vertical ribs that connect vertically adjacent lateral ribs to each other.

### Additional Note 5

The vehicle front section structure according to any one of Additional Notes 1 to 4, further including a cover portion that covers an open cross-section of the bent portion.

What is claimed is:

1. A vehicle front section structure comprising:
a front side member that extends in a vehicle front-rear direction;
a crash box that is disposed further toward a vehicle front side than the front side member;
a bumper reinforcement that is disposed further toward the vehicle front side than the crash box and that extends in a vehicle width direction; and
a receiving member that is disposed between and couples the front side member and the crash box and that projects out further toward a vehicle width direction outer side than the front side member, a bent portion that is bent toward the vehicle front side and toward a vehicle width direction inner side being provided at an end portion at a vehicle width direction outer side of the receiving member.

2. The vehicle front section structure according to claim 1, wherein an edge of a leading end of the bent portion is rounded.

3. The vehicle front section structure according to claim 1, wherein the receiving member is integrally formed with the front side member by casting.

4. The vehicle front section structure according to claim 3, wherein the receiving member is configured to include a plurality of lateral ribs that are disposed at intervals in a vehicle up-down direction, and vertical ribs that connect vertically adjacent lateral ribs to each other.

5. The vehicle front section structure according to claim 1, further comprising a cover portion that covers an open cross-section of the bent portion.
